(19) United States
(12) Patent Application Publication
(10) Pub. No.: US 2010/0299534 A1
(43) Pub. Date: Nov. 25, 2010

(54) DATA STORAGE DEVICE AND DATA STORAGE SYSTEM

(75) Inventors: Jun Seok SHIM, Seongnam-si (KR); Young Sun PARK, Suwon-si (KR)

Correspondence Address: VOLENTINE & WHITT PLLC, ONE FREEDOM SQUARE, 11951 FREEDOM DRIVE SUITE 1260, RESTON, VA, 20190, US

(73) Assignee: SAMSUNG ELECTRONICS CO., LTD., Suwon-si (KR)

(21) Appl. No.: 12/783,831

(22) Filed: May 20, 2010

(30) Foreign Application Priority Data
May 22, 2009 (KR) 10-2009-0044820

(51) Int. Cl. G06F 12/14

(52) U.S. Cl. 713/189

(57) ABSTRACT

In a data storage device, unauthorized access to stored data in the data storage device can be effectively prevented by encrypting and storing security data needed for data encryption, setting an encryption key to encrypt/decrypt the security data by a user, and receiving the encryption key from a host, if necessary, not storing the encryption key in the data storage device.

### CROSS-REFERENCE TO RELATED APPLICATIONS

This application claims priority from Korean Patent Application No. 10-2009-0044820 filed on May 22, 2009, the subject matter of which is hereby incorporated by reference.

### BACKGROUND

The inventive concept relates to data storage technology, and more particularly, to a data storage device capable of effectively preventing malicious access by a third party to important data stored in the data storage device by encrypting and storing security data required for data encryption, user-setting of an encryption key to encrypt/decrypt the security data, and receiving the encryption key from a host, as necessary, as opposed to storing the encryption key in the data storage device.

Hard disk drives (HDDs) are widely used to store large amounts of data, such as (e.g.) multimedia data. HDDs are an excellent choice for storing large quantities of data, as compared with other auxiliary memory devices, due to their random data access capability, superior data transfer speed, low cost per unit storage, and large data storage capacity. As the use of HDDs increases, the security of data stored on a HDD becomes a more important question. Accordingly, the demand for the encryption of data stored on a HDD, and/or a commensurate user access permission procedure has greatly increased.

An encryption key is generally needed for the data encryption, or operative initiation of an HDD having a similar security function. The encryption key must be safe from third party attack, yet relatively easy to access and change by the authorized user.

Certain electronic modules have been designed for use within HDDs to store encryption key(s). But such electronic modules tend to increase the operating complexity of constituent hard disk controllers, as well as increase overall manufacturing cost. Thus, certain design objectives have suggested that contemporary hard disk controllers must be better adapted to deal with the incorporation of electronic modules.

### SUMMARY

However, embodiments of the inventive concept provide data storage devices capable of safely storing an encryption key without using an additional electronic module unit. Other embodiments of the inventive concept provide data storage systems incorporating such data storage devices.

Embodiments of the inventive concept provide a data storage device comprising; a first encryption unit configured to encrypt data using an encryption key and provided corresponding encrypted data to a data storage unit within the data storage device, and a second encryption unit configured to encrypt keyed security data including the encryption key using a re-encryption key and provided corresponding encrypted keyed security data to the data storage unit.

At least one of the encryption key and the re-encryption key may be externally provided to the data storage device.

The data storage device may further comprises an interface unit facilitating an exchange of data between the data storage device and a host device, and re-encryption key is externally provided by the host to the data storage device via the interface unit.

The data storage device may be a hard disk drive (HDD).

The HDD may comprises a hard disk configured to store the encrypted data and the encrypted keyed security data.

The encrypted keyed security data may be stored in a system track of the hard disk.

The re-encryption key may be provided as a user defined password or user biometric data.

The HDD may further comprise a third encryption unit configured to encrypt the re-encryption key using a different encryption key provide by the host.

Embodiments of the inventive concept also provide a data storage system comprising; a data storage device configured to receive data via a bus, and a processor configured to control operation of the data storage device. The data storage device comprises; a first encryption unit configured to encrypt data using an encryption key and provided corresponding encrypted data to a data storage unit within the data storage device, and a second encryption unit configured to encrypt keyed security data including the encryption key using a re-encryption key and provided corresponding encrypted keyed security data to the data storage unit.

### BRIEF DESCRIPTION OF THE DRAWINGS

Exemplary embodiments of the inventive concept will be more clearly understood from the following detailed description taken in conjunction with the accompanying drawings in which:

FIG. 1 is a schematic block diagram of a data storage device according to an embodiment of the inventive concept;

FIGS. 2A and 2B are flowcharts summarizing a data encryption method and a data decryption method according to certain embodiments of the inventive concept; and

FIG. 3 is a general block diagram of a data storage system incorporating a data storage device according to an embodiment of the inventive concept.

### DETAILED DESCRIPTION OF THE EMBODIMENTS

The attached drawings illustrate certain embodiments of the inventive concept and may be referred to in order to gain a sufficient understanding of the inventive concept and the merits thereof. Hereinafter, the inventive concept may be variously embodied and should not be construed as being limited to only the illustrated embodiments. Throughout the drawings and written description, like reference numbers and labels refer to like or similar elements.

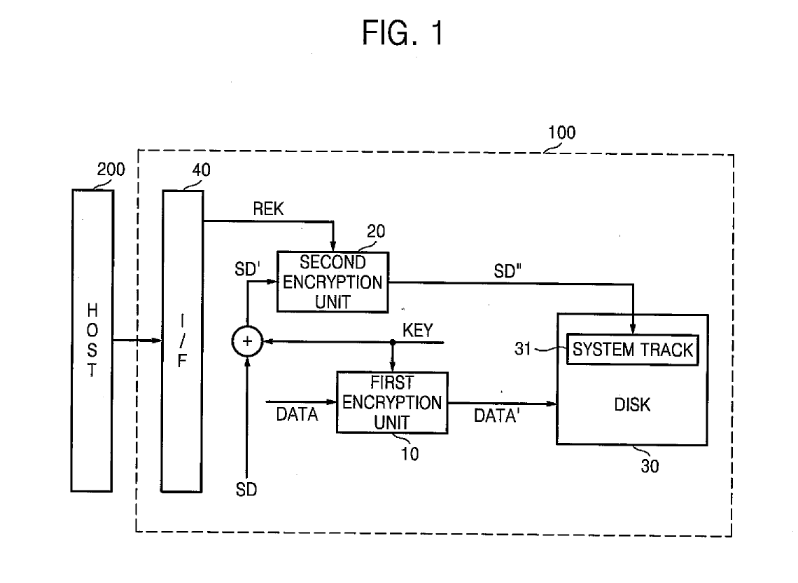

Figure (FIG. 1 is a schematic block diagram of a data storage device 100 according to an embodiment of the inventive concept. In the illustrated embodiment, although a hard disk drive (HDD) is assumed as an example, the present inventive concept is not limited thereto. For example, other embodiments may incorporate a solid state drive (SSD), a non-volatile memory, a volatile memory, or an optical disk drive (ODD), etc.

The data storage device 100 may additionally include a preamplifier (not shown), a read/write channel (not shown), a host interface (not shown), a voice coil motor (VCM) driver (not shown), a spindle motor (SPM) driver (not shown), and a hard disk controller (not shown). The preamplifier may be used to amplify a data signal that is reproduced by a magnetic head (not shown) from a disk (not shown). The amplified write signal or write current may be recorded on the disk by using the magnetic head.

The read/write channel may be used to convert the signal amplified by the preamplifier to a digital signal and transfer the digital signal to a host device (not shown) via the host interface. Also, the read/write channel may receive data input by a user via the host interface, convert the received user data to binary data stream, and transfer the binary data stream to the preamplifier.

The host interface may transfer the data converted to a digital signal to the host device, or receive the user data from the host device and transfer the received user data to the read/write channel via the hard disk controller. The VCM driver may control the amount of current applied to a VCM (not shown) under the control of the hard disk controller. The SPM controller may control the amount of current applied to the SPM under the control of the hard disk controller.

The hard disk controller in a data write mode may receive the data that the user input via the host device, via the host interface, and output the received data to the read/write channel. The hard disk controller in a data read mode may receive and process a read signal converted to a digital signal by the read/write channel and output the processed data to the host interface. Also, the hard disk controller may control the output of a VCM drive unit (not shown) and an SPM drive unit (not shown).

The hard disk controller may be a microprocessor or a microcontroller and implemented in form of software or firmware. Also, the hard disk controller may perform data encryption/decryption operations according to an exemplary embodiment of the present inventive concept.

Since the foregoing components are deemed to be well understood by those skilled in the art a detailed description is not given here for the sake of brevity and clarity.

The data storage device 100 illustrated in FIG. 1 generally comprises a first encryption unit 10 configured to encrypt data (DATA) received (e.g.) from a host 200, a second encryption unit 20 configured to encrypt keyed security data SD′, and an interface unit (I/F) 40 configured to control and facilitate the exchange of data between the host 200 and data storage device 100. In the illustrated embodiment, the data storage device 100 is assumed to further comprise a data storage area, (e.g.) a hard disk 30 capable of storing encrypted data (DATA′), security data SD, encrypted-keyed security data SD″, and/or a variety of encryption keys. Since the data storage device 100 includes at least one defined security function, the data (DATA) and associated security data SD may not necessarily be directly stored on hard disk 30, but may first be stored in a separately provided memory following encryption.

The first encryption unit 10 is configured to receive and encrypt the data (DATA) and then provide encrypted data (DATA′). The encrypted data (DATA′) will be stored (directly or indirectly through a memory not shown) to a designated area of the hard disk 30. The first encryption unit 10 will use an encryption key (KEY) to perform a corresponding encryption operation. In certain embodiments of the inventive concept, the encryption key (KEY) may be stored in a particular area, (e.g.) a system track 31 on the hard disk 30.

Assuming the use of one or more conventionally understood protocols, in an advanced technology attachment (ATA) method, a serial ATA (SATA) method, or a parallel ATA (PATA) method, when a password required for user authentication is stored in a particular area of hard disk 30 and this particular area is denied access to the host 200, it is impossible for the host to read the stored password. Yet it must be possible for some non-user partiers (e.g., the hard disk manufacturer) to access the system track 31 during hard disk testing or code debugging. Accordingly, some appropriate third parties may be allowed access to the system track 31. This necessary capability unfortunately allows unauthorized third parties to hack various security information including an encryption key (KEY) stored in the system track 31.

In view of this conventional design tradeoff, the data storage device 100 according to embodiments of the inventive concept is configured to store the keyed security data SD′ including the encryption key (KEY) by re-encrypting the keyed security data SD′ using the second encryption unit 10. In this manner, the security data SD once connected with the encryption key (KEY) is not merely stored in an easily discernable form (e.g., plane text), so that the security of all of the data stored on the hard disk 30 may be further enhanced.

In this context, it should be noted that in certain embodiments of the inventive concept, an encryption key (KEY) may be generated by using a random number and the random number may be generated from a digital signal provided within the data storage device 100.

As noted above with reference to FIG. 1, the data storage device 100 comprises the second encryption unit 20 in addition to the first encryption unit 10. The second encryption unit 20 may encrypt the keyed security data SD′ and output encrypted keyed security data SD″. A defined re-encryption key (REK) may be used to perform the second encryption operation performed within the second encryption unit 20. The re-encryption key (REK) may be set by the user. As conceptually suggest by the embodiment of FIG. 1, the re-encryption key (REK) may not be stored in any area of the hard disk 30, but may (optionally) be provided from the host 200 via the interface unit 40.

The actual form of the keyed security data SD′ will vary by design, and may be distinct from security data SD conventionally provided with a data storage device. For example, the keyed security data SD′ may include all security related data, such as the encryption key (KEY) to be used during the first encryption operation performed by the first encryption unit 10.

Thus, the keyed security data SD′ will be encrypted by the second encryption unit 20 before being stored back to the hard disk 30. In other words, only encrypted keyed security data SD″ will be stored on the hard disk 30, and as such, it much better immunized to unauthorized third party hacking In certain embodiments of the inventive concept, the encrypted keyed security data SD″ will be stored in the system track 31 of the hard disk 30. In other embodiments of the inventive concept, the encrypted keyed security data SD″ will be stored in an area of the hard disk 30 designated by the user or hard disk manufacture.

It is also possible within the certain embodiments of the inventive concept, that the re-encryption key (REK)—that should under ideal circumstances be retained by the user—may additionally be backed-up on the data storage device 100. For example, a universal serial bus (USB) that may be connected to the data storage device 100 to access a backed-up re-encryption key (REK) stored on the hard disk 30 or elsewhere in the data storage device 100. Such USB access capabilities may facilitate remote access to the backed-up re-encryption key (REK) by a trusted source.

Thus, since the encryption key (KEY) stored on the hard disk 30 is encrypted by the re-encryption key (REK) before being stored back to the hard disk 30, even when a third party knows the specific location of the stored the encryption key (KEY) and/or similar security data, it will be impossible to recognize this data, as stored on the hard disk 30, unless the third party also acquires the re-encryption key (REK).

When the date storage device 100 is manufactured, the re-encryption key (REK) may be set to a default value. Thereafter, upon first user activity, the user may change the re-encryption key (REK) to one of his/her own liking using (e.g.,) a basic input/output system (BIOS) or similar utility program commonly and conventionally associated with contemporary electronics. When an authorized user changes the re-encryption key (REK), the encrypted keyed security data SD″ stored in the HDD 100 will be automatically re-encrypted using the new re-encryption key (REK).

Thus, the first encryption unit 10 and second encryption unit 20 used within embodiments of the inventive concept will use one or more encryption algorithm(s). Possible encryption algorithms may be classified into symmetric key cryptosystems and asymmetric key cryptosystems. Symmetric key cryptosystems (e.g., the so-called data encryption system DES) use the same encryption key for encryption and decryption and are conventionally well understood. Contemporary DES uses a 56 bit encryption key and exhibits excellent stability.

Asymmetric key cryptosystems use different encryption keys for encryption and decryption and may perform encryption/decryption by using a correlation between a public key and a private key. One or more conventionally understood encryption algorithms, such as Rivest-Shamir-Adleman (RSA) algorithm, SEED algorithm, triple DES (3DES) algorithm, fast data encryption algorithm (FEAL), an international data encryption algorithm (IDEA), Ron's code (RC) 2, RC4, RC5, skipjack, blowfish, or secure and fast encryption routine (SAFER) may be used within certain embodiments of the inventive concept.

As noted above, the data storage device 100 may receive the re-encryption key (REK) for encryption of the keyed security data SD′ from the host 200 via the interface unit 40, if necessary, without saving the re-encryption key (REK) to the hard disk 30. Receipt of the re-encryption key (REK) from the host 200 may be accomplished using one of a number of well understood approaches.

For example, the user may input the re-encryption key (REK) in the form of a password through an input device, (e.g., a keyboard), in the form of a tag signal based on radio frequency identification (RFID) technology, or in the form of biometric data (e.g., an iris, fingerprint, or voice imprint). As also noted above, the re-encryption key (REK) may be input to the data storage device 100 from an external device via a conventional connection (e.g., a USB port) by an authorized user. Thus, the re-encryption key (REK) need not be stored in any memory location with the data storage device 100.

In certain embodiments of the inventive concept, the first and/or second encryption operations may be performed more than once to further improve security of the data stored within the data storage device 100. To this end, the data storage device 100 may further comprise a third encryption unit (not shown) to encrypt the re-encryption key (REK) and double re-encrypt the keyed security data SD′, including the security data required to operate the third encryption unit. Like the re-encryption key (REK), the double encryption key may be received from the host 200 through the interface unit 40.

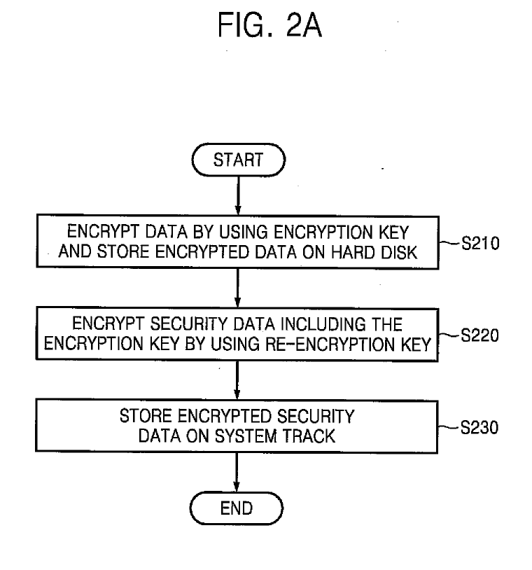

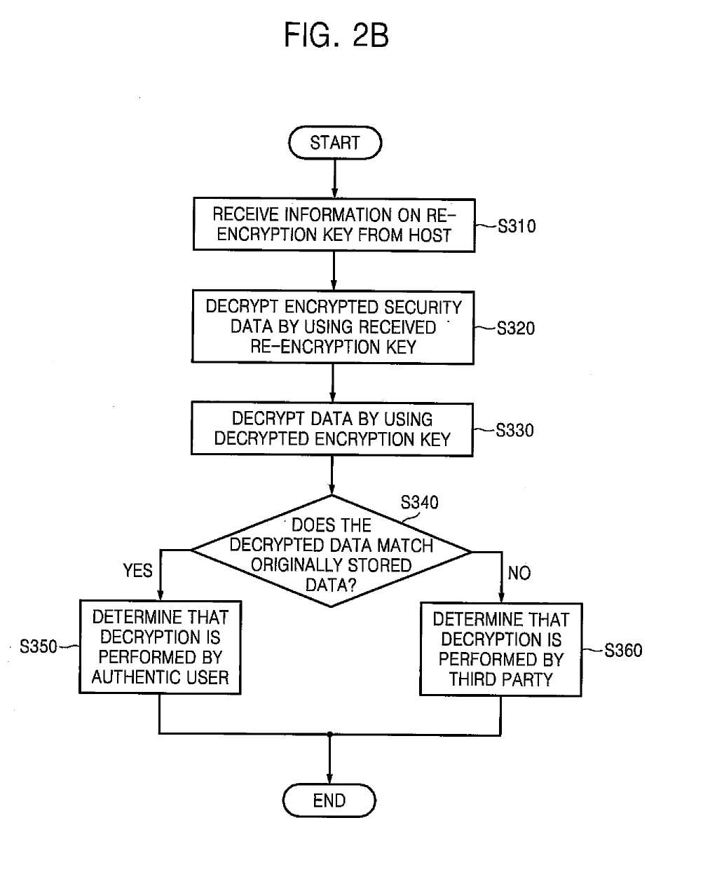

FIGS. 2A and 2B are flowcharts summarizing a data encryption method and a data decryption method according to embodiments of the inventive concept. FIG. 2A is a flowchart summarizing a data encryption process performed by the data storage device 100 according to an embodiment of the inventive concept. Referring to FIGS. 1 and 2A, the first encryption unit 10 encrypts the data (DATA) to be stored in the hard disk 30 using the encryption key (KEY), and provides the encrypted data DATA′ to the hard disk 30 for storage (S210).

Next, the second encryption unit 20 encrypts the keyed security data SD′ including the encryption key (KEY) using the re-encryption key (REK) and provides the encrypted keyed security data SD″ to the hard disk 30 for storage (S220). The encrypted keyed security data SD″ may be stored in a designed area, for example, the system track 31, of the hard disk 30 (S230).

FIG. 2B is a flowchart summarizing a data decryption process performed in the data storage device 100 according to an embodiment of the inventive concept. Referring to FIGS. 1 and 2B, information regarding the re-encryption key (REK) is assumed to be received in the second encryption unit 20 from the host 200 (S310) via the interface unit 40.

A decryption unit (e.g., either one of the first and second encryption units) is used to perform decryption within the data storage device 100. First, the encrypted keyed security data SD″ is decrypted using the re-encryption key (REK) received from the host 200 (S320). In this case, it is assumed that the data storage device 100 operates as a symmetric key cryptosystem. Then, since the encryption key (KEY) necessary to decrypt the encrypted data (DATA′) has now been obtained, the encrypted data (DATA′) may be conventionally decrypted (S330).

In a data decryption method according to an embodiment of the inventive concept, the data decryption process may be performed based on the information on the received re-encryption key without determining whether the information on the re-encryption key received from the host 200 is correct or not. Thus, by checking whether the finally decrypted data matches the actually stored data (S340), it may be determined whether the information on the initially received re-encryption key REK is correct or not. For example, when the data match with each other, it may be determined that the decryption is performed as an authentic user inputs the information on the re-encryption key REK (S350). When the data do not match with each other, it may be determined that the decryption is performed as a third party inputs the information on the re-encryption key REK (S360).

As described above, even when the decryption is performed as a third party inputs the information on the re-encryption key REK, since the finally output data is different from the data originally stored in the hard disk 30, leakage of information and data due to unauthorized access by a third party to a memory device may be effectively prevented.

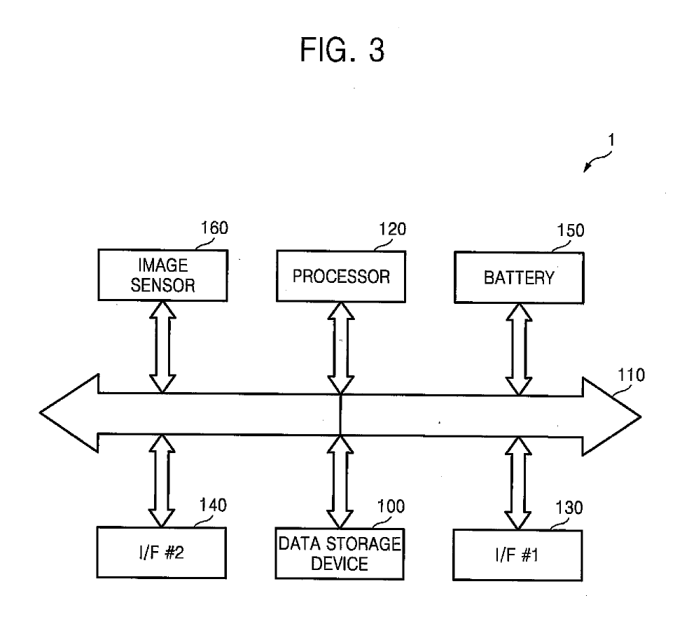

FIG. 3 is a schematic block diagram of a data storage system 1 including a data storage device according to an exemplary embodiment of the present inventive concept. Referring to FIGS. 1-3, the data storage system 1 according to the present exemplary embodiment may include the data storage device 100 connected to a system bus 110 and a processor 120.

The processor 120 may generate control signals to control a program operation or write operation, a read operation, or a verify operation of the data storage device 100. Thus, a control block (not shown) of the data storage device 100 may perform the program operation or write operation, the read operation, or the verify operation in response to a control signal output from the processor 120. Also, the processor 120 may perform the data encryption/decryption functions of the first and second encryption units 10 and 20 of FIG. 1.

The data storage method or data encryption method according to the present inventive concept can also be embodied as computer readable codes on a computer readable recording medium. The computer readable recording medium may be any data storage device that can store data which can be thereafter read by a computer system. Examples of the computer readable recording medium include read-only memory (ROM), random-access memory (RAM), CD-ROMs, magnetic tapes, floppy disks, optical data storage devices, etc. The computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains.

When the data storage system 1 according to the present exemplary embodiment is embodied by a portable application, the data storage system 1 may further include a battery 150 to supply operation power to the data storage device 100 and the processor 120. The portable application may include portable computers, digital cameras, personal digital assistants (PDAs), cellular telephones, MP3 players, portable multimedia players (PMPs), automotive navigation systems, memory cards, system cards, game consoles, electronic dictionaries, or solid state disks.

The data storage system 1 may further include an interface, for example, an input/output device (I/F #1) 130, to exchange data with an external data storage device. When the data storage system 1 according to the present exemplary embodiment is a wireless system, the data storage system 1 may further include a wireless interface 140 (I/F #2). In this case, the wireless interface 140 may be connected to the processor 120 and wirelessly transceive data with an external wireless device via the system bus 110.

The wireless system may be wireless devices such as PDAs, portable computers, wireless telephones, pagers, or digital cameras, RFID readers, or RFID systems. Also, the wireless system may be a cellular network.

When the data storage system 1 according to the present exemplary embodiment is an image pickup device, the data storage system 1 may further include an image sensor 160 that can convert an optical signal to an electric signal. The image sensor 160 may be an image sensor using a charge-coupled device (CCD), or a complementary metal-oxide semiconductor (CMOS) image sensor. In this case, the data storage system 1 may be a digital camera or a mobile phone having a digital camera function. Also, the data storage system 1 according to the present exemplary embodiment may be a satellite system having a camera attached thereto.

As described above, in the data storage device according to embodiments of the inventive concept, since security of stored data is further improved, malicious access by an unauthorized third party may be prevented. Also, since an additional device such as a security electronic module is not needed, the overall complexity of a device may be greatly reduced.

While the inventive concept has been particularly shown and described with reference to exemplary embodiments thereof, it will be understood that various changes in form and details may be made therein without departing from the scope of the following claims.

What is claimed is:

1. A data storage device comprising:
a first encryption unit configured to encrypt data using an encryption key and provided corresponding encrypted data to a data storage unit within the data storage device; and
a second encryption unit configured to encrypt keyed security data including the encryption key using a re-encryption key and provided corresponding encrypted keyed security data to the data storage unit.

2. The data storage device of claim 1, wherein at least one of the encryption key and the re-encryption key is externally provided to the data storage device.

3. The data storage device of claim 2, further comprising an interface unit facilitating an exchange of data between the data storage device and a host device, and re-encryption key is externally provided by the host to the data storage device via the interface unit.

4. The data storage device of claim 1, wherein the data storage device is a hard disk drive (HDD).

5. The data storage device of claim 4, wherein the HDD comprises a hard disk configured to store the encrypted data and the encrypted keyed security data.

6. The data storage device of claim 5, wherein the encrypted keyed security data is stored in a system track of the hard disk.

7. The data storage device of claim 6, wherein the re-encryption key is provided as a user defined password or user biometric data.

8. The data storage device of claim 4, wherein the hard disk drive further comprises a third encryption unit configured to encrypt the re-encryption key using a different encryption key provide by the host.

9. A data storage system comprising:
a data storage device configured to receive data via a bus; and
a processor configured to control operation of the data storage device,
wherein the data storage device comprises:
a first encryption unit configured to encrypt data using an encryption key and provided corresponding encrypted data to a data storage unit within the data storage device; and
a second encryption unit configured to encrypt keyed security data including the encryption key using a re-encryption key and provided corresponding encrypted keyed security data to the data storage unit.

10. The data storage system of claim 9, wherein at least one of the encryption key and the re-encryption key is externally provided to the data storage device.

11. The data storage system of claim 10, further comprising an interface unit facilitating an exchange of data between the data storage device and the processor, and re-encryption key is externally provided by the processor to the data storage device via the bus and the interface unit.

12. The data storage system of claim 9, wherein the data storage device is a hard disk drive (HDD).

13. The data storage system of claim 12, wherein the HDD comprises a hard disk configured to store the encrypted data and the encrypted keyed security data.

14. The data storage system of claim 13, wherein the encrypted keyed security data is stored in a system track of the hard disk.

15. The data storage system of claim 14, wherein the re-encryption key is provided as a user defined password or user biometric data.

16. The data storage system of claim 12, wherein the HDD further comprises a third encryption unit configured to encrypt the re-encryption key using a different encryption key provided by the host.
